(19) United States
(12) Patent Application Publication
(10) Pub. No.: US 2009/0110528 A1
(43) Pub. Date: Apr. 30, 2009

(54) LIFT MECHANISM

(76) Inventors: Joshua Walter, Bremen, IN (US); Heber Hernandez, Elkhart, IN (US); Francisco Villa Lobos, Elkhart, IN (US)

Correspondence Address: BOTKIN & HALL, LLP, 105 E. JEFFERSON BLVD., SUITE 400, SOUTH BEND, IN, 46601, US

(21) Appl. No.: 11/923,988

(22) Filed: Oct. 25, 2007

(51) Int. Cl. B66F 7/02; B66F 11/04

(52) U.S. Cl. 414/609; 254/266; 294/67.1

(57) ABSTRACT

A lifting mechanism having a first frame and a second frame. The second frame is movable relative to the first frame. A pulley is rotatably attached to one of the frames and a means for rotating the pulley is provided. A cordage is attached at one end to the pulley and another end of the cordage is attached to one of the frames. As the pulley is rotated the second frame is moved relative to the first frame.

### BACKGROUND OF THE INVENTION

Lifting mechanisms for televisions and beds are generally complex and have many moving parts. Prior art lifts for such items often involve long extruded tracks and elaborate frames that must be attached to walls. Long extruded tracks and complicated mechanisms are expensive not only because of the extra material in the mechanism itself, but also due to additional labor required to install elaborate components onto the walls of a room where the lifting mechanism is to be used. Thus, there remains a need for an improved lift mechanism, which does not require an elaborate framework and that has a minimum number of moving parts.

### SUMMARY OF THE INVENTION

The present invention is a lifting mechanism for lifting objects such as a bed or a monitor. In an embodiment suited for lifting a monitor, a rod is rotatably held in a first frame. The first frame is affixed to a substantially vertical structure such as a wall. The first frame may be an extruded track. A second frame has a sliding portion, an arm and a mounting bracket. The sliding portion has rollers that are slidingly retained within the extruded track and allow the entire second frame to move vertically. A strap is affixed to the rod at one end and another end of the strap is attached to the second frame. The rod acts as a pulley and winds the strap around the rod when turned by a motor connected to the rod. As the motor turns the rod to wind the strap onto the rod the second frame and the monitor are lifted. The motor may be turned in an opposite direction to lower the television by unwinding the strap from the rod. A remotely located switch is used to connect current to the motor. The switch may connect current to the motor so that it turns the rod in a direction to wind the strap onto the rod. The switch may also connect current to the motor so that it turns the rod in a direction not unwind the strap from the rod. When the switch is switched to raise the monitor the motor will turn the rod to wind the strap onto the rod until the second frame contacts an upper switch which disconnects current from the motor to prevent it from moving the second frame above the upper switch. Similarly, when the switch is switched to lower the monitor the motor will turn the rod to unwind the strap the until the second frame contacts a lower switch which disconnects current from the motor to prevent it from moving the second frame below the lower switch.

Another embodiment of the invention is suited to lift a bed or other objects supported on the horizontal structure. A first frame is made of the walls and ceiling of a room. A second frame is slidingly retained within the first frame and may move vertically. The second frame has rollers which roll against the walls to provide lateral stability. A motor is attached to the underside of the second frame and is connected to a shaft rotatably retained by bushings on the second frame. The shaft has a set of outer pulleys at the ends of the shaft and a set of inner pulleys that are next to the outer pulleys. Outer straps are received by the outer pulleys and inner straps are received by the inner pulleys. The motor turns the shaft to wind or unwind the straps on the pulleys to evenly raise or lower the second frame and bed. Similar switches may be employed in this embodiment to stop the motor from moving the second frame past its fully raised or lowered position.

### BRIEF DESCRIPTION OF THE DRAWINGS

FIG. 1 is a perspective view of a first embodiment of the lift of this invention shown with a flat panel monitor, with the lift retracted behind a cabinet;

FIG. 2 is a an exploded perspective view of the lift shown in FIG. 1;

FIG. 3 is a side view of the lift shown in FIG. 1, with the lift in the raised position;

FIG. 4 is a side view of the lift shown in FIG. 1, with the lift in the down position;

FIG. 5 is a view of the lift shown in FIG. 1, with the lift in the raised position;

FIG. 6 is a perspective view of a second embodiment of the invention shown supporting a bed in its first configuration;

FIG. 7 is a perspective view showing the components of the lift shown in FIG. 6;

FIG. 8 is a perspective view of the lift shown in FIG. 6 installed in a vehicle;

FIG. 9 is a side view of the lift shown in FIG. 6 installed in a vehicle with the lift in a partially lowered position;

FIG. 10 is a side view of the lift shown in FIG. 6 installed in a vehicle with the lift in a fully raised position; and

FIG. 11 is a perspective view of a second embodiment of the invention shown supporting a bed in its second configuration.

### DETAILED DESCRIPTION OF INVENTION

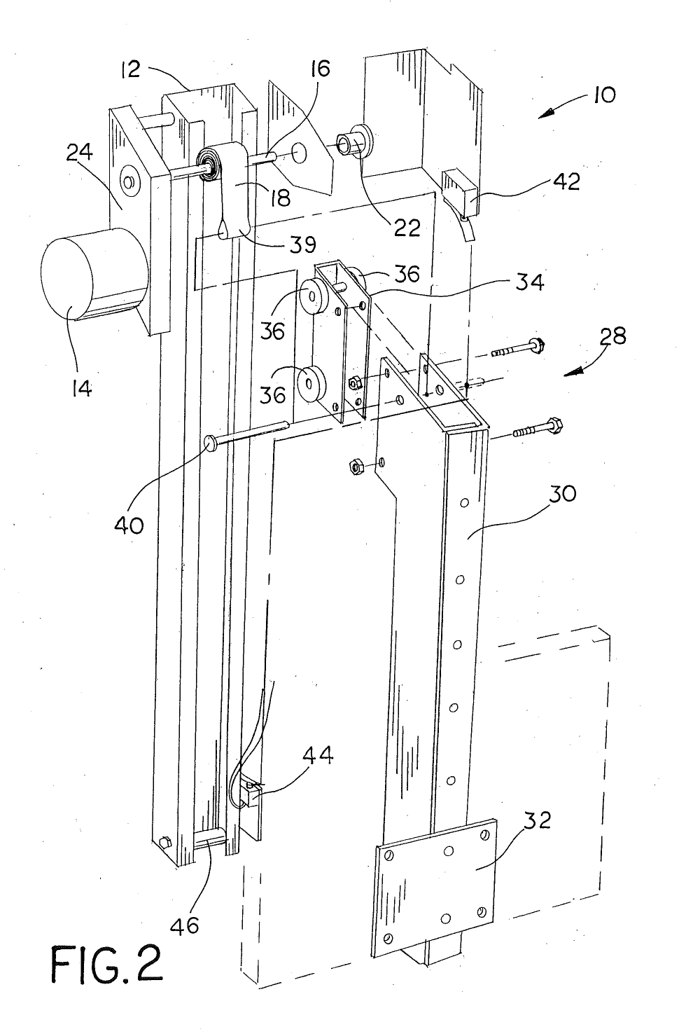

The lifting mechanism of this invention 10 in one embodiment has a first frame that is an extruded track 12 mounted to a wall or other vertical surface. An exploded view of this embodiment is shown in FIG. 2. A motor 14, which is operated by switch in a remote location, is mounted at the top of the extruded track 12 and turns a rod 16 that acts as a pulley and winds a strap 18 around the rod 16. The strap 18 may be any cordage that is flexible enough to be wound around a pulley or rod. A first end of the strap 18 which is wrapped around the rod 16 is firmly attached to the rod 16 so that no slippage occurs. The switch is operatively connected to the motor 14 so that it may be switched to connect current to the motor 14 to rotate the rod 16 counterclockwise as viewed from the left. Since the strap 18 is wound over the top of the rod 16 counterclockwise rotation of the rod 16 will cause the strap 18 to be wound upon the rod 16. FIG. 2 best shows how the strap 18 is wound upon the rod 16. The switch may also connect current to the motor 14 to rotate the rod 16 clockwise as viewed from the left side. This will cause the strap 18 to be unwound from the rod 16. The rod 16 is supported at one end by a bushing 22 and is turned by the motor 14 at the other end through a gear box 24. A second frame 28 has an arm 30, a mounting bracket 32, a sliding portion 34 and a pin 40. The arm 30 is connected to the sliding portion 34, which slides in the extruded track 12. Rollers 36 are mounted on both sides of the sliding portion 34 and are slidingly retained within the extruded track 12. The sliding portion 34 is bolted to the arm 30. The mounting bracket 32 is permanently attached to the arm 30 and has four holes 36 that are in a standard pattern, which is common to most flat panel monitors and televisions.

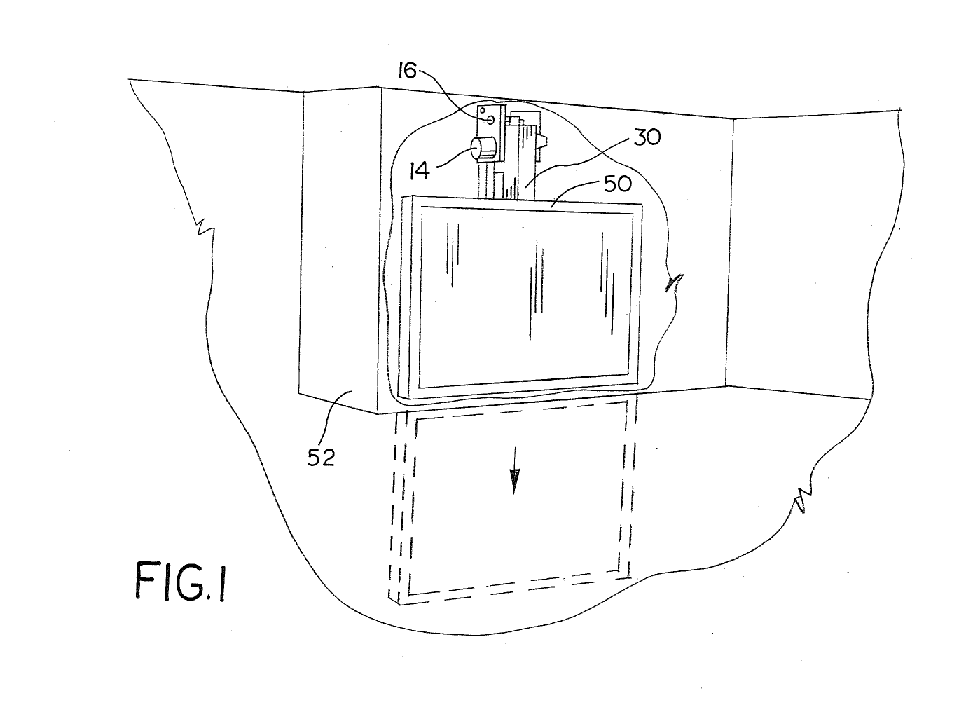

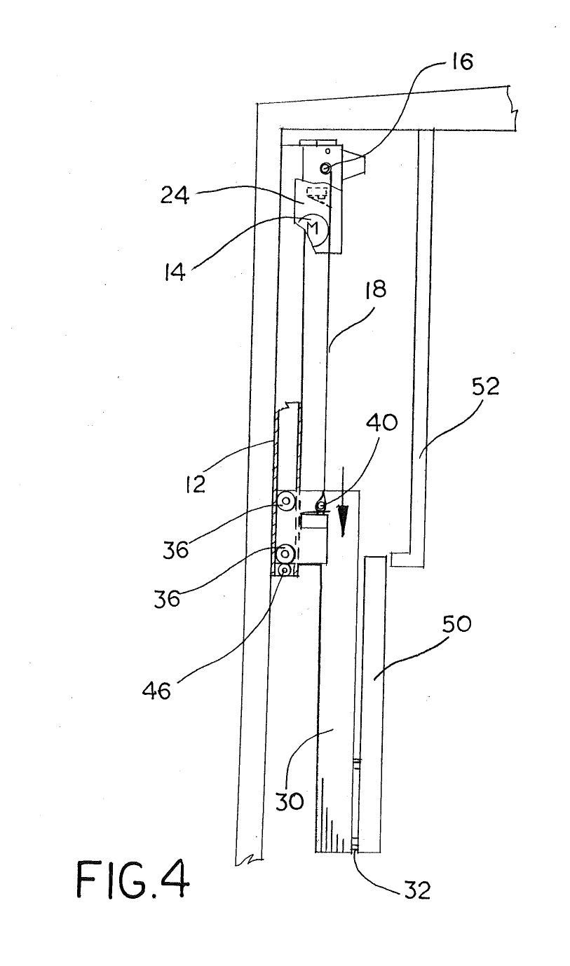

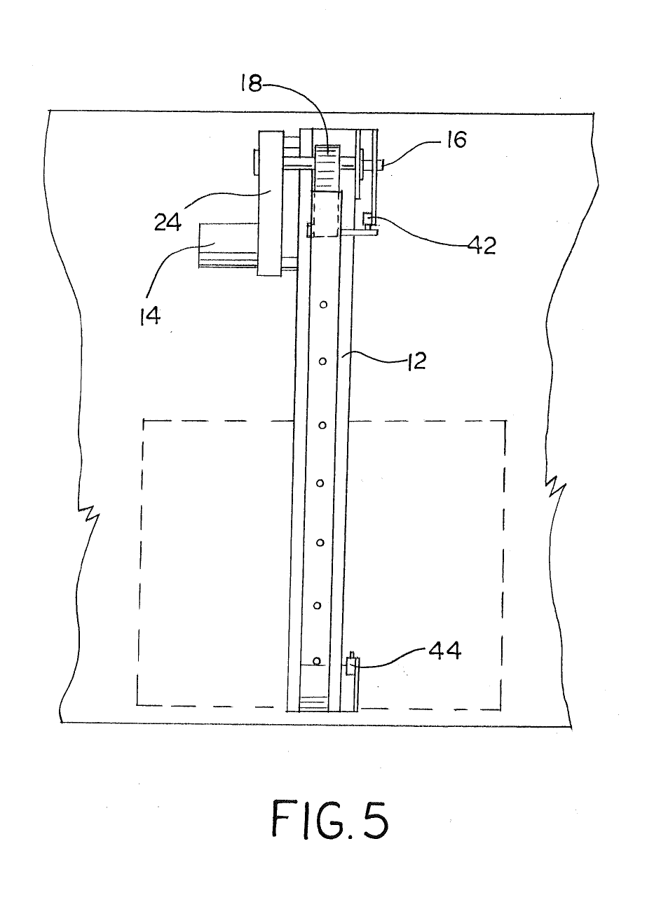

The strap 18 has a loop 39 at its second end that wraps around the pin 40 to attach the strap 18 to the second frame 28 and hold the second frame 28 in its vertical position. When the arm 30 is in its fully raised, first position, as shown in FIGS. 1, 3, and 5, most of the length of the strap 18 is wound around the rod 16. The pin 40 protrudes through the arm 30 and is placed so that it may contact an upper switch 42 or a lower switch 44 depending on the position of the arm 30. When the arm 30 is in its fully raised position the pin 40 contacts the upper switch 42 to break the flow of current to the motor 14 required to turn the rod 16 counterclockwise. This prevents the arm 30 from being lifted above the point where the pin 40 contacts the upper switch 42 and also prevents the sliding portion 34 from jamming against the strap 14 as it is wound around the rod 16. When the arm 30 is in its fully lowered, second position, as shown in FIG. 4, most of the length of the strap 18 is unwound from the rod 16. In this position, the pin 40 contacts a lower switch 44 to break the flow of current to the motor 14 required to turn the rod 16 clockwise. This prevents the arm 30 from being lowered beyond the point where the pin 40 contacts the lower switch 44. A safety pin 46 is placed near the end of the extruded track 12 to prevent the sliding portion 34 from leaving the track 12 in the event that either the lower switch 44 or strap 18 has failed.

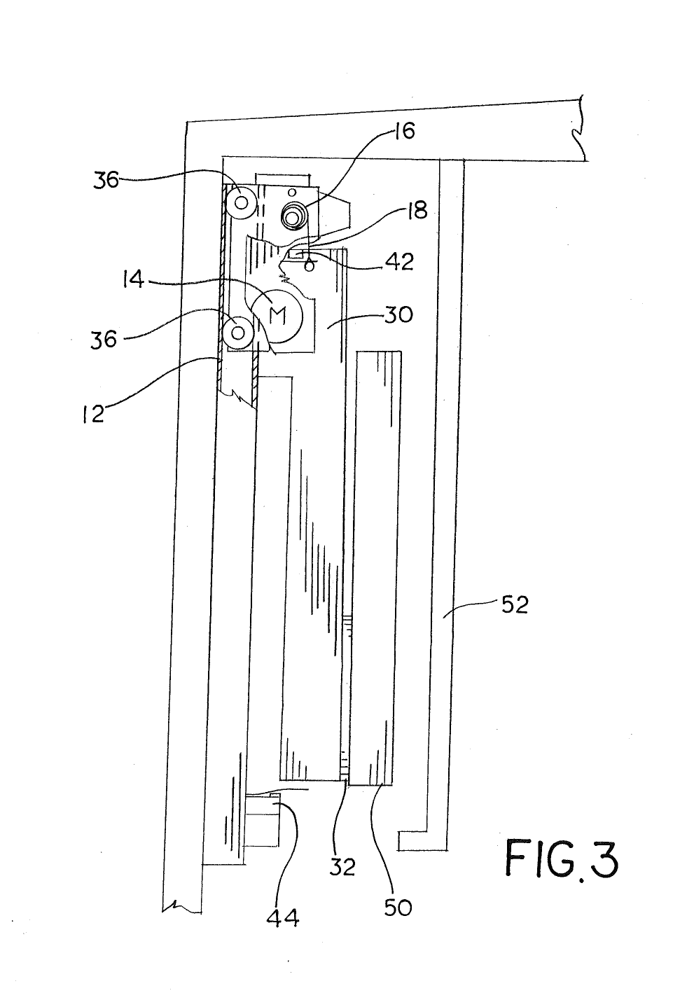

The lifting mechanism 10 of this embodiment is suited for raising or lowering a flat panel monitor 50. A flat panel monitor 50 is mounted onto the mounting bracket 32 by placing screws in the four holes 36 of the mounting bracket 32, which will align with holes in a flat panel monitor 50. As shown in FIG. 1 the lifting mechanism 10 may be placed behind a cabinet 52 to hide the monitor 50 when it is not in use. FIG. 1 shows the fully raised, first position, which is also shown in FIG. 3. When a user wishes to use the monitor 50 he may then switch the switch to lower the monitor 50 and the motor 14 will turn the rod 16 clockwise to unwind the strap 18 from the rod 16. When the monitor 50 reaches its fully lowered, second position, as shown in FIG. 4 the pin 40 will contact the lower switch 44, which will place the monitor 50 in a viewing position, yet allow the lifting mechanism 10 to remain hidden behind the cabinet 52. When the user wishes to hide the monitor 50, the switch may be reversed to raise the monitor 50 and the motor 14 will stop raising the monitor 50 when the pin 40 contacts the upper switch 42.

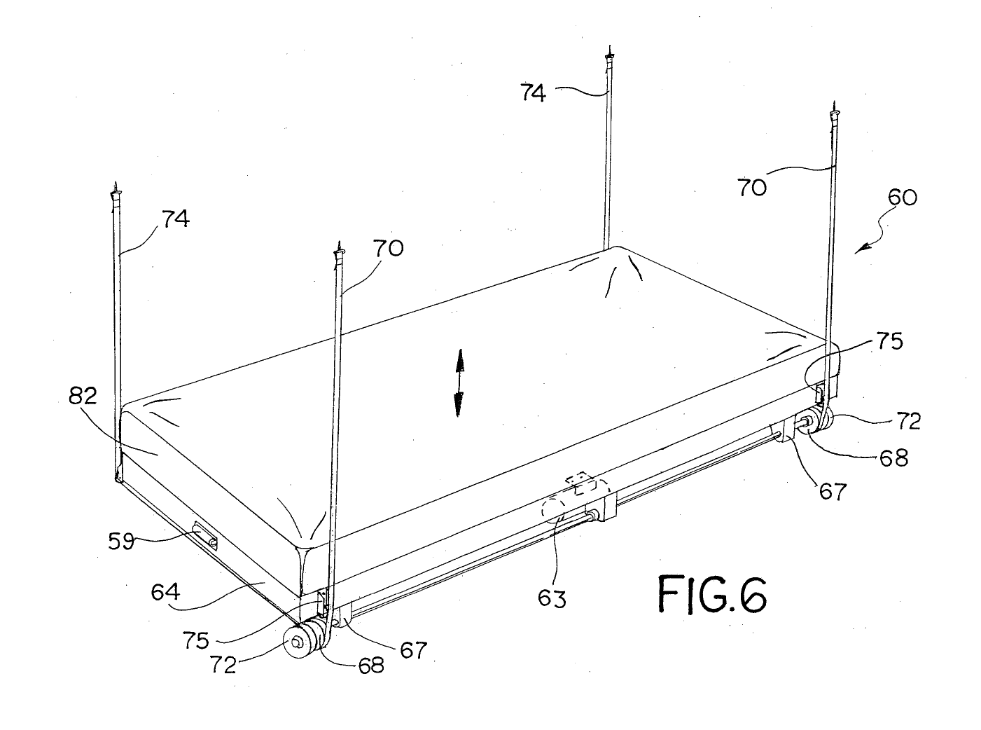

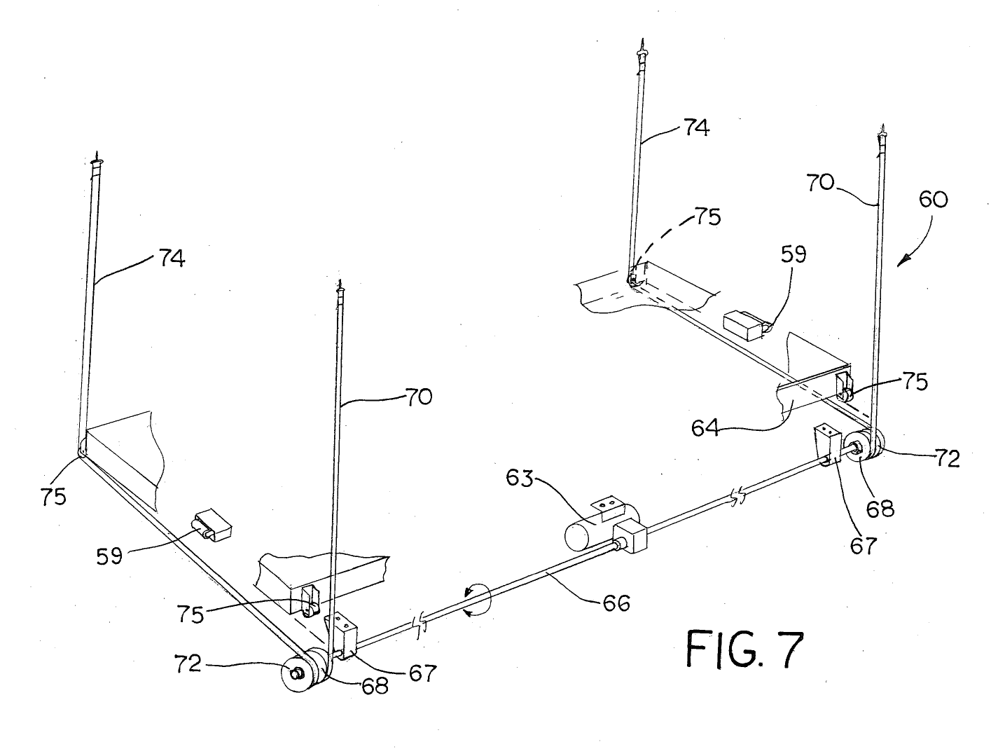

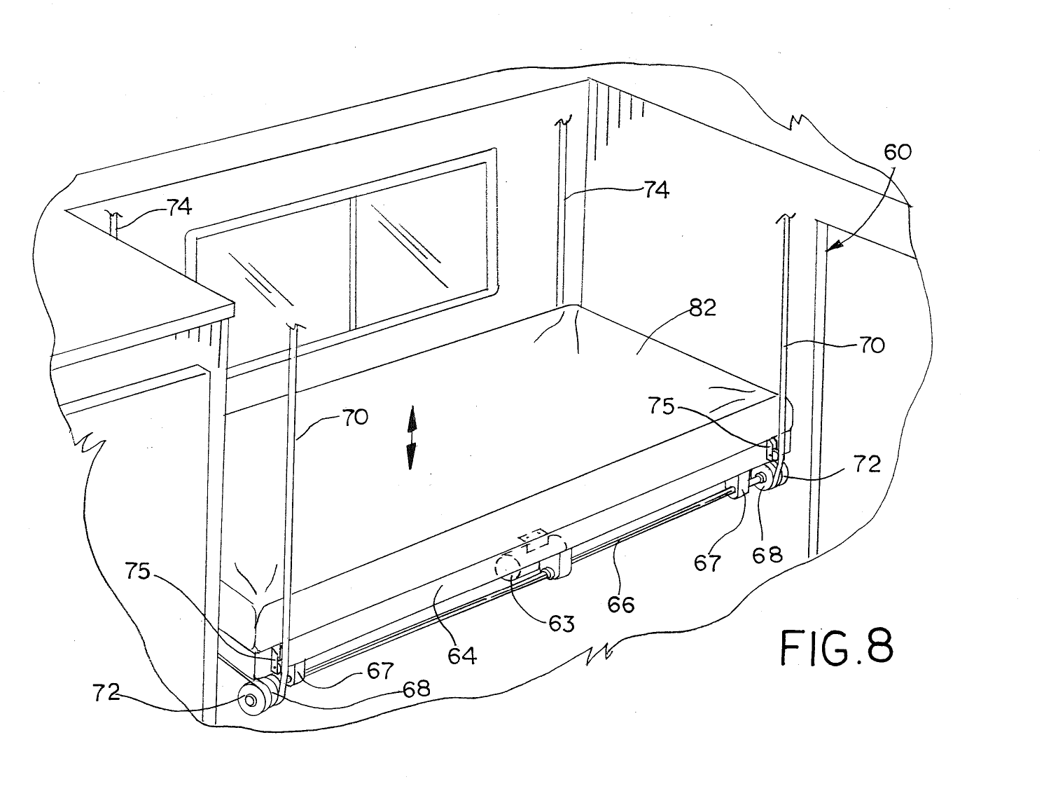

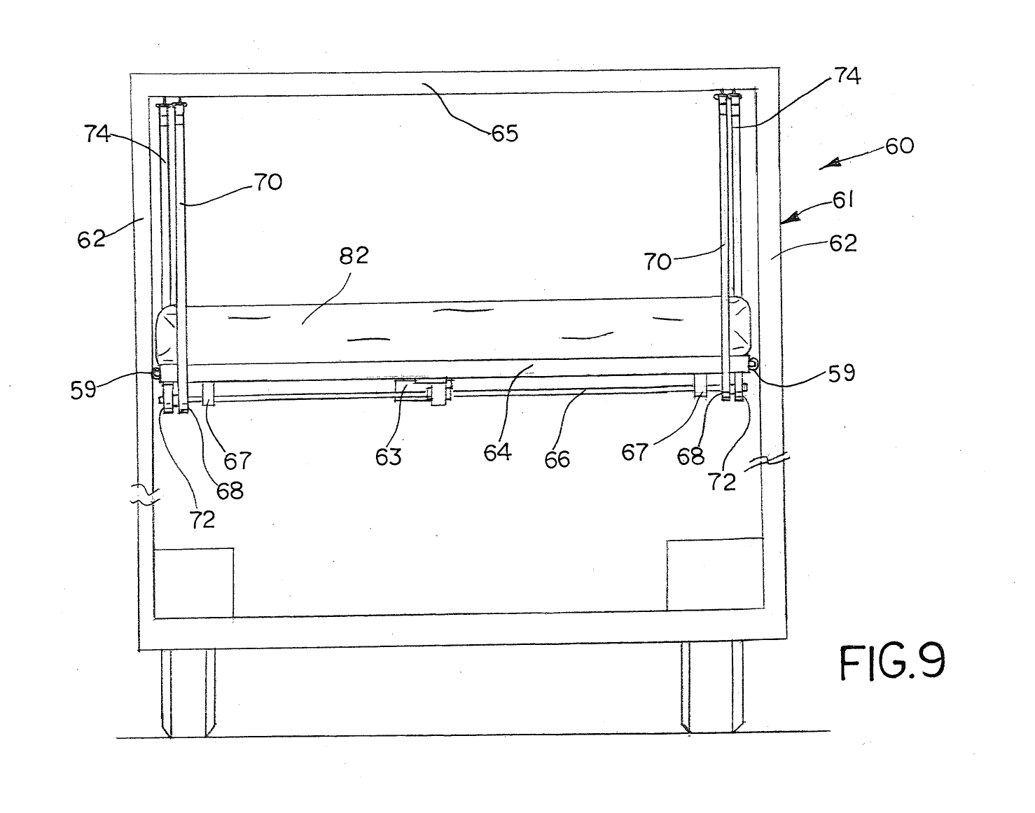

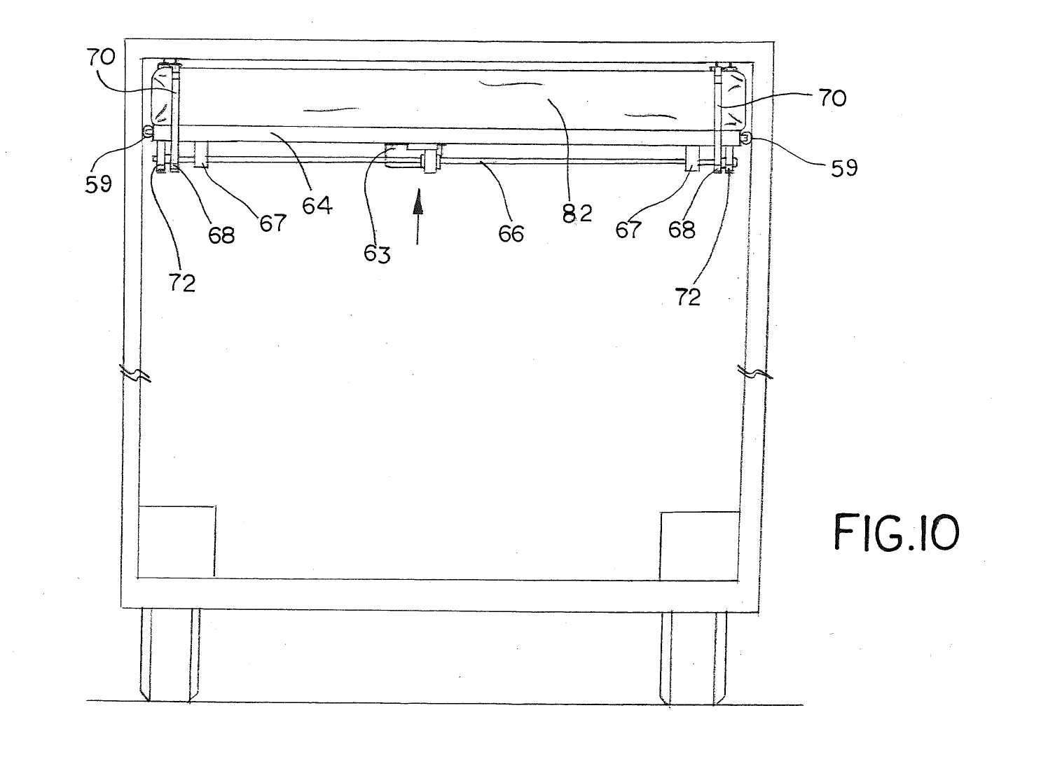

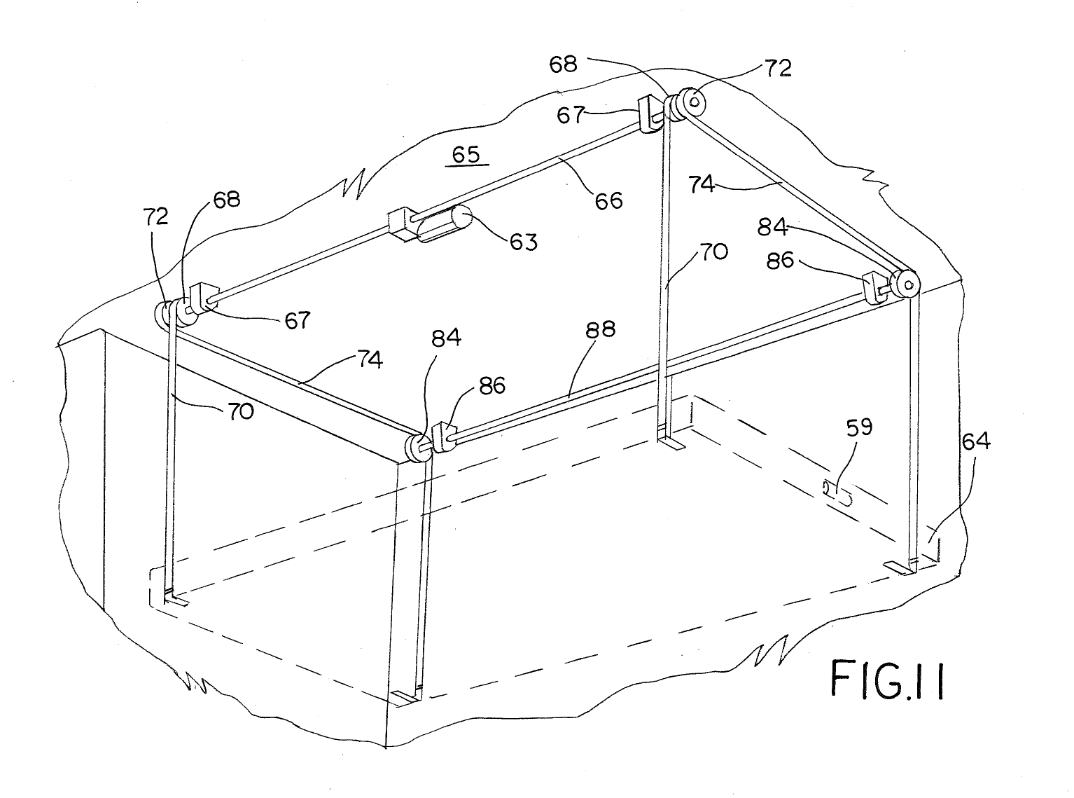

Another embodiment of the lifting mechanism 60 is shown in FIGS. 6-11. An exploded view of this embodiment in a first configuration is shown in FIG. 7 and a second configuration is shown in FIG. 11. In this embodiment the first frame 61 is made of walls 62 and a ceiling 65 of a room. A second frame 64 is slidingly retained within the first frame 61. The second frame 64 includes rollers 59 which roll along the walls 62 to provide lateral guidance for the second frame 64. Extruded tracks may also be placed along the walls 62, to provide further guidance for the rollers 59, but are not necessary. A motor 63, which is operated by a switch in a remote location, is connected to the second frame 64 from below and drives a shaft 66. The shaft is rotatably held by bushings 67 to the second frame 64. The shaft 66 has outer pulleys 72 which are at the ends of the shaft 66 and inner pulleys 68 that are next to the outer pulleys 72. The switch is operatively connected to the motor 63 so current may be connected to the motor 63 so that it will rotate the shaft 66 and pulleys 68, 72 clockwise as viewed from the left end of the shaft 66. The switch may also connect current to the motor 63 so that it rotate the shaft 66 and pulleys 68, 72 counterclockwise as viewed from the left end of the shaft. The inner pulleys 68 receive inner straps 70, and the outer pulleys 72 receive outer straps 74. Ends of each strap 70, 74 are attached to the pulleys 68, 72 so that no slippage occurs. The other ends of the straps 70, 74 are attached to the ceiling 65. The straps 70, 74 wrap around the pulleys 68, 72 and hold the second frame 64 in its vertical position. The inner straps 70 are wound around the inner pulleys 68 from the bottom and the outer straps 74 are wound around the outer pulleys 74 from the top. The inner and outer pulleys 68, 72 are the same diameter. This configuration, which can be seen most clearly in FIG. 7, will wind or unwind all of the straps 70, 74 the same amount for each revolution of the shaft 66. As the straps 70, 74 are wound or unwound from the pulleys 68, 72 the second frame 64 will move relative to the straps 70, 74 and rollers 75 prevent the straps 70, 74 from rubbing on the second frame 64.

This embodiment may also have the motor 63 mounted to the ceiling 65, which is a part of the first frame 61. FIG. 11 shows the second configuration with the motor 63 mounted to the ceiling 65. In this configuration the bushings 67 holding the shaft 66 are mounted to the ceiling 65. The inner and outer straps 70, 74 are wound around the pulleys 68, 72 in a similar fashion to the previously mentioned configuration. Another set of pulleys 84 are mounted to the ceiling 65 with bushings 86 that rotatably hold a shaft 88. The pulleys 84 provide guidance to the outer straps 74. As the straps 70, 74 are wound or unwound from the pulleys 68, 72 the straps 70, 74 will pull the second frame up or down.

This embodiment of the lift mechanism 60 is suited for lifting a bed 82 which is placed on the second frame 64. When a user wishes to lower the bed from its stored, first position he will switch the switch so that the motor 63 rotates the shaft 66 and pulleys 68, 72. In the first configuration the shaft 66 and pulleys 68, 72 rotate counterclockwise as viewed from the left end of the shaft 66 to lower the bed 82. In the second configuration the shaft 66 and pulleys 68, 72 rotate clockwise as viewed from the left end of the shaft 66 to lower the bed. Since all of the pulleys 68, 72 are the same diameter, the straps 70, 74 are unwound from the pulleys 68, 72 evenly. This provides even movement of the bed 82 downward. When the bed 82 is fully lowered in its second position the user will switch the switch so that it disconnects the current from the motor 63. Alternatively, the second frame 64 can be set to contact a switch mounted on a wall 62 that will disconnect the current to the motor 63 when the bed 82 is fully lowered. When the user wishes to raise the bed to the stored position, the user will switch the switch so that the motor 63 rotates the shaft 66 and pulleys 68, 72 in the opposite direction necessary to lower the bed 82. In the first configuration the shaft 66 rotates clockwise as viewed from the left end to raise the bed 82, and in the second configuration the shaft 66 rotates counterclockwise as viewed from the left end to raise the bed 82. Once the second frame 64 is fully raised the user will switch the switch to stop the motor 63, or a switch may be placed on a wall 62 that the second frame 64 will contact to disconnect the current from the motor 63 and stop further upward movement.

The above described invention is not to be limited to the details given but may be modified within the scope of the following claims.

What is claimed is:

1. A lifting mechanism comprising:
a first frame;
a second frame movable relative to said first frame and having a first position and a second position;
a means for rotating a pulley, said pulley being rotatably attached to one of said frames; and
a cordage having an end affixed to said pulley so that said cordage may be wrapped around said pulley, another end of said cordage is affixed to the frame not attached to said pulley so that rotation of said pulley causes movement of said second frame relative to said first frame.

2. A lifting mechanism as claimed in claim 1, wherein said pulley is attached to said first frame and said rotating means is a motor.

3. A lifting mechanism as claimed in claim 2, wherein said first frame is a track, said second frame is an arm having a sliding portion, said sliding portion slidably retained within said track.

4. A lifting mechanism as claimed in claim 3, wherein said arm is adapted for attachment to a flat panel monitor or television.

5. A lifting mechanism as claimed in claim 2, wherein said second frame contacts a switch when in said first position disconnecting current from said motor, said second frame contacts another switch in said second position disconnecting current from said motor, thereby limiting travel of said second frame to a select one of a plurality of positions between said first position and said second position.

6. A lifting mechanism as claimed in claim 2, wherein said motor and said pulley are attached to said second frame so that said motor, said pulley and said second frame can move as a single unit relative to said first frame.

7. A lifting mechanism as claimed in claim 6, wherein said second frame includes a planar surface.

8. A lifting mechanism as claimed in claim 7, wherein said second frame includes rollers that roll within said first frame.

9. A lifting mechanism as claimed in claim 6, wherein said second frame contacts a switch when in said first position disconnecting current from said motor, said second frame contacts another switch in said second position disconnecting current from said motor, thereby limiting travel of said second frame to a select one of a plurality of positions between said first position and said second position.

10. A lifting mechanism comprising:
a stationary first frame;
a movable second frame that is movable relative to said first frame and having a first position, a second position, and a plurality of positions between said first and second positions;
a means for rotating a pulley, said pulley being rotatably attached to one of said frames; and
a cordage having an end affixed to said pulley so that said cordage may be wrapped around said pulley, another end of said cordage is affixed to the frame not attached to said pulley so that rotation of said pulley causes movement of said movable second frame relative to said stationary first frame.

11. A lifting mechanism as claimed in claim 10, wherein said pulley is attached to said first stationary frame and said rotating means is a motor.

12. A lifting mechanism as claimed in claim 11, wherein said movable second frame contacts a switch when in said first position disconnecting current from said motor, said movable second frame contacts another switch in said second position disconnecting current from said motor, thereby limiting travel of said movable second frame to a select one of a plurality of positions between said first position and said second position.

13. A lifting mechanism as claimed in claim 10, wherein said motor and said pulley are attached to said movable second frame so that said motor, said pulley and said movable second frame can move as a single unit relative to said stationary first frame.
